(19) United States
(12) Patent Application Publication
(10) Pub. No.: US 2002/0191882 A1
(43) Pub. Date: Dec. 19, 2002

(54) Polarisation dependent loss generators

(76) Inventor: David Simon George, London (GB)

Correspondence Address: Mark D Saralino, Renner Otto Boisselle & Sklar, 19th Floor, 1621 Euclid Avenue, Cleveland, OH, 44115, US

(21) Appl. No.: 10/149,557

(22) PCT Filed: Oct. 26, 2001
(86) PCT No.: PCT/GB01/04767

(30) Foreign Application Priority Data
Oct. 28, 2000 (GB) 0026413.5

(51) Int. Cl. G02B 6/00

(52) U.S. Cl. 385/11

(57) ABSTRACT

A polarisation dependent loss (PDL) compensator for receiving from a transmission system radiation having TM and TE polarisation components comprises a waveguide structure for separating the TM and TE polarisation components, the reference numerals denoting the TM mode axis and the TE mode axis corresponding to the TM and TE fundamental mode heights within the waveguide structure. Differential coupling losses are introduced by positioning the ends of input/output fibres relative to the axes to generate a required amount of coupling PDL, that is for applying a first loss to the TM polarisation component and a second loss to the TE polarisation component. If the waveguide structure has positive PDL (TE mode loss greater than TM mode loss), for example, the output fibre may be aligned with the TE mode axis to reduce TE coupling loss relative to TM coupling loss, thus inducing a negative coupling PDL. Such a compensator is capable of applying compensating losses such that the total losses are the same for the two polarisation modes. As a result the PDL is reduced substantially to zero, and the received power will be substantially constant regardless of polarisation changes in the signal.

### BACKGROUND OF THE INVENTION

This invention relates to polarisation dependent loss (PDL) generators and is concerned more particularly, but not exclusively, with such generators for use in optical fibre communication systems and integrated optical circuits.

Optical fibre communication systems and optical fibre based devices require coupling of optical fibres with integrated optical devices. However a particular problem arises due to the fact that, after transmission through an optical fibre, the state of polarisation of a light beam is unpredictable due to the random nature of the birefringence arising from fibre non-circularity, bending, stress and other inhomogeneities. Furthermore the losses incurred in most optical components are dependent on polarisation. As a result, the power of the received light in an optical fibre communication system will depend on the polarisation dependent losses (PDL) of the optical components of the system, and such losses can accumulate considerably for a large system. In simple intensity modulation, for instance, the received power for the one polarisation state may be vastly different from that for another. The same problems could arise for coherent systems in which a receiver mixes the incoming signal with a local oscillator signal. In this case fading will occur if the incoming polarisations are not matched to the local oscillator signals. Furthermore, if the data is encoded by polarisation modulation, the variation of the polarisation state by the transmission medium may lead to cross-talk at the receiver.

In addition the state of polarisation and the PDL may vary in time, and will generally be different for each link in a network. Consequently it is impossible to calibrate the system with a single reference signal. For incoherent systems it may be possible to use depolarised light. However, this is impractical since the signal would quickly pick up a degree of polarisation as it propagated through the various components. Accordingly it would seem that the only possibility to minimise such differential losses is to ensure that each component has substantially zero PDL so that the received power will be substantially constant as the polarisation changes.

Polarisation dependent loss is the part of the total loss that changes as the polarisation is varied over all possible states. In general, the PDL is defined as the maximum loss for the component minus the minimum loss for the component, as the polarisation is varied over all possible states. For an integrated optical waveguide device, the modes are often of a quasi-linear polarisation state, either Transverse Electric (TE) or Transverse Magnetic TM why not delete ‘(TE)’ also?. For the TE mode the electric field lies predominantly in the transverse plane, whereas for the TM mode the magnetic field lies predominantly in the transverse plane (so the electric field lies in the vertical plane). Since these modes usually have the minimum and maximum losses the PDL may be defined as the TE loss minus the TM loss.

GB 2317023A, GB 2335504A, GB 2344933A, GB 2239102A and U.S. Pat. No. 5,787,214 are examples of prior disclosures relating to arrangements for coupling optical fibres to waveguide structures so as to provide a good optical connection and accurate alignment. None of these references is specifically concerned with the disadvantageous effects of polarisation dependent losses.

JP 2000241643A discloses an optical device incorporating a waveguide portion having a core which provides some PDL compensation. JP 080166563A discloses an optical device comprising a polarisation splitter which acts to split the polarisation components vertically, and a collimator module whose relative position can be arranged to control the proportion of each polarisation component which is outputted and which can accordingly be adjusted to compensate for polarisation dependent losses. However neither of these devices is ideal for compensating for PDL at the interface between an optical fibre and a waveguide structure. It is an object of the invention to provide a PDL generator which is capable of compensating for the disadvantageous effects of polarisation dependent losses in an optical transmission system.

### SUMMARY OF THE INVENTION

According to the present invention there is provided a polarisation dependent loss generator for receiving from an optical transmission system an optical signal having first and second polarisation components, the generator comprising a waveguide structure having an input for receiving an optical signal and an output, and having a geometry such that the first and second polarisation components have different extents within the height of the waveguide structure, and an optical element optically coupled to the input or the output of the waveguide structure and positioned relative to the waveguide structure so as to generate different optical coupling losses for the first and second polarisation components as a result of the different overlaps of the optical element with the different lateral extents of the first and second polarisation components, in order to at least partially compensate for the polarisation dependent losses of the transmission system.

Such a device is capable of compensating for PDL at the interface between and (delete ‘and’?) the waveguide structure and an optical fibre, waveguide or photodiode acting as the optical element, and therefore enable the PDL compensation to be effected in a straightforward manner.

In a preferred application, in which the generator acts as a PDL compensator, the first and second losses applied are such that the sum of the first loss and the loss for the first polarisation component from the transmission system is substantially the same as the sum of the second loss and the loss for the second polarisation component from the transmission system.

It will be appreciated that such a PDL generator is capable of applying compensating losses which have the effect of producing substantially the same total loss for each polarisation mode, for example for each of the TE and TM modes. As a result the PDL is reduced to substantially zero, and the received power will be substantially constant regardless of polarisation changes in the signal.

However the generator is also capable of being used to apply losses to the two polarisation components such that different overall losses are experienced by the polarisation components, for example to permit the generator to act as a polariser serving to vary the ratio of the polarisation components or even to suppress one polarisation component entirely.

The generator may be designed to apply fixed compensating losses which will remain the same throughout the operational life of the system. However the generator may also include adjustment means which can be manually operated to vary the losses in order to compensate the system, although in this case, once compensated, the losses will remain the same throughout the operational life of the system. Alternatively the generator may include means for automatically adjusting the losses in response to feedback so as to compensate the PDL in real time.

### BRIEF DESCRIPTION OF THE DRAWINGS

For a better understanding of the present invention and to show how the same may be carried into effect, reference will now be made, by way of example, to the accompanying drawings, in which:

FIG. 1 is an explanatory diagram illustrating the principle behind the invention;

FIG. 2 is an explanatory diagram illustrating an embodiment of the invention;

FIG. 3 is a block diagram of an embodiment of the invention;

FIGS. 4A and 4B are graphs, for a particular example, of the minimum overlap loss and difference in position of maximum overlap against waveguide width; and

FIGS. 5A and 5B are graphs, for a particular example, of the coupling loss, average loss and PDL against fibre position.

### DETAILED DESCRIPTION OF THE DRAWINGS

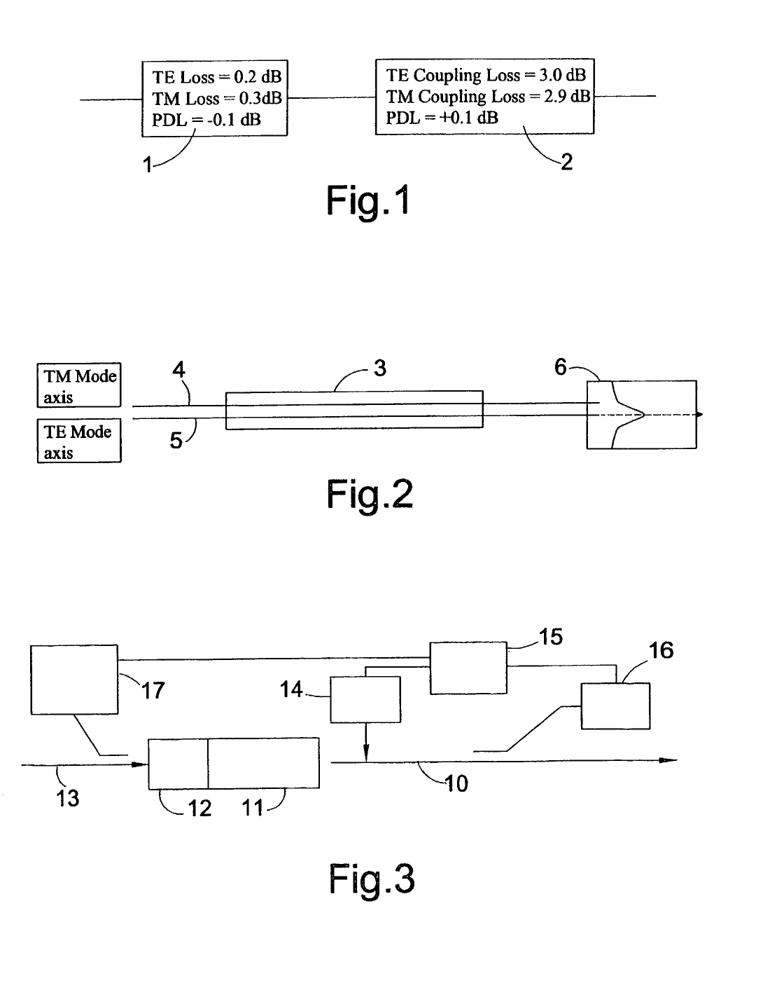

Referring to FIG. 1 the principle of the invention is to compensate the PDL associated with the component 1 by introducing opposite PDL by means of a coupling PDL generator 2. In the example of FIG. 1 the component has a TE mode loss of 0.2 dB and a TM mode loss of 0.3 dB, that is an average loss of 0.25 dB and a PDL of −0.1 dB. To compensate for this PDL, a deliberate amount of coupling PDL is introduced by the generator 2, as a result of the waveguide design and the relative positioning of the coupled components, amounting to a TE mode coupling loss of 3.0 dB and a TM mode coupling loss of 2.9 dB giving a PDL of +0.1 dB. Consequently an average total loss of 3.2 dB is produced, and the total PDL is zero. Ideally the additional coupling loss introduced by the compensator 2 is as low as possible (in this case it is 2.95 dB, although theoretically the minimum is 0.1 dB for TE and 0.0 dB for TM, i.e. 0.05 dB on average).

The PDL generator 2 may be placed anywhere in the system, as long as it is between the polarisation varying source and the receiver. It may include a tapered section of waveguide to enable it to be connected to a waveguide of different dimensions.

FIG. 2 diagrammatically shows a waveguide 3 which has been designed to maximise the field movement as the polarisation is varied, and in particular so as to vertically differentiate the TM and TE modes to enable control of the relative coupling losses of these modes. In this regard it should be noted that it would be more usual in designing an optical component to minimise the field movement as the polarisation is varied with the object of minimising the PDL. 4 and 5 denote the TM mode axis and the TE mode axis corresponding to the TM and TE fundamental mode heights being at different heights within the waveguide. It will be appreciated that differential coupling losses can be introduced by positioning the ends of input and/or output optical fibres or waveguides (or some other optical element, such as a photodiode) relative to the axes 4 and 5 to generate a required amount of coupling PDL. In the illustrated example, preferably the output fibre 6 is aligned with the TE mode axis 5, as shown in FIG. 2. This is preferable to movement of the input fibre since this could excite higher order modes (the structure potentially being multi-mode). If the PDL to be compensated is positive (TE mode loss greater than TM mode loss), then the output fibre is aligned with the TE mode axis 5 to reduce TE coupling loss relative to TM coupling loss, thus inducing a negative coupling PDL.

In one implementation the fibre is moved to a position for generating the desired coupling PDL and is then fixed in position during manufacture. Such an arrangement may be useful for a particular component which is known to have a certain amount of PDL which requires compensating. This implementation could be used to produce a packaged device having zero PDL. Furthermore the fibre itself could be optimised to provide the required degree of overlap. For example a narrow core fibre may give better results.

In an alternative implementation the fibre position may be adjustable, for example utilising a piezoelectric actuator, to enable a controlled amount of PDL to be generated. This may take the form of a pigtailed device which is connected into the system to compensate PDL. In this case the device may be calibrated during assembly, but its setting would not be changed during subsequent operation.

In a further implementation the fibre position may be automatically adjustable to compensate component PDL in real time for applications in which the PDL varies with time. Such a servo control system is shown diagrammatically in FIG. 3 which shows a system for controlling the position of an output fibre 10 with respect to the output end of a waveguide structure 11 which is in turn coupled to an optical system 12 supplied with an input light signal by an input fibre 13. The movement of the output fibre 10 is effected by a piezoelectric actuator 14 which is itself controlled by processing electronics 15 in response to a feedback signal from a photodiode 16 which monitors the power of the light outputted along the output fibre 10. In addition an inline polarisation controller 17 is provided to input to the system 12 a reference signal having a polarisation which is varied over the Poincare sphere so that the processing electronics 15 coupled to both the polarisation controller 17 and the photodiode 16 can monitor the output power levels for each polarisation and provide feedback to move the output fibre 10 to compensate the PDL. The processing electronics 15 positions the output fibre 10 so as to minimise the power variation as the polarisation changes and so as to maximise the average coupled power. The variable polarisation reference signal may be transmitted along the output fibre 10 simultaneously with the data. However, due to the complexity of links in a network, it is preferred that the compensation system should be operated locally for a few components, rather than globally.

The PDL generator may be further integrated by using on-chip microelectromechanical (MEM) technology to change the coupling efficiency with respect to an output waveguide, rather than an output fibre. This would greatly increase the versatility and stability of the device. Furthermore the output waveguide could be tailored to optimise the average coupling efficiency. The PDL generator may either be a stand-alone device or may be integrated with other devices on a chip. Furthermore, in order to increase the range of PDL compensation, PDL generators may be cascaded together, although this would increase the overall loss of the system.

In an alternative, non-illustrated embodiment the output fibre or waveguide is replaced by a photodiode which is aligned to detect maximum output power and so as to minimise PDL. In this case the photodiode provides an electrical output signal indicative of the detected optical power but does not itself couple the optical signal for onward transmission along an output fibre or waveguide. Preferably a mirror is provided for reflecting the light transmitted from the output end of the waveguide structure through an angle, for example 90°, towards the active area of the photodiode. The photodiode is deliberately misaligned relative to the reflected beam so as to balance the TE and TM modes in order to minimise the PDL and, as a result, some light of one polarisation mode passes to one side of the active area and is lost.

In order to provide a quantitative basis for the invention a number of simulated experiments were performed. These provided information on how the guide dimensions affect the mode position as the polarisation is varied. The simulations employed silicon on insulator waveguide structures having ribs of width w fabricated by etching an epitaxial (epi) layer to an etch depth of h, the thickness of the layer t being equal to h+s where s is the depth of the unetched part of the layer and the etch ratio is r=h/s. The simulations were performed for waveguides in 9.3 micron epi, having a range of widths from about 12.5 μm to 1.5 μm and an etch depth h of 5 μm, as well an etch depth h of 6.7 μm. In each case the oxide index was 1.447 and the silicon index was 3.4764. The simulations determined the coupling losses for the TE and TM fundamental modes to standard optical fibre (Mode Field Diameter=10.5 microns). It will be appreciated that these simulations demonstrate proof of concept and that the type of waveguide (materials and dimensions) and input/output coupling means (eg fibre) are not specific to the invention.

Experimental Results

Simulations were performed using BBV Selene Temperature 4.0 to determine the extent of fundamental mode movement as the polarisation was rotated from TE to TM, (ignoring polarisation conversion along the guide), with a view to the mode movement being used to allow the position of a fibre coupled to the waveguide to compensate for PDL. The presence of movement implies the PDL measured will depend on initial fibre alignment position. Waveguide dimensions were found that maximise this mode movement.

The position of maximum intensity was calculated for TE and TM fundamental modes. The aim was to induce the maximum height difference between the modes when the polarisation is rotated from TE to TM, while maintaining the largest overlap with a gaussian mode (fibre mode field diameter (MFD) of 10.5 μm). Because of the symmetry, only vertical movement was generated. Simulations were performed for an epi thickness of 9.3 μm.

It was observed that, as the ridge width is varied, there is a transition region over which the fundamental modes move up from the slab into the ridge of the waveguide. This occurs at different widths for the TE polarisation and the TM polarisation. Therefore, at a particular ridge width there is a maximum height difference in the TE and TM modes which increases as the etch depth is increased. This geometry will have a higher fibre coupling loss, and a trade-off is necessary between the mode height difference that it is possible to generate by changing polarisation and the average fibre coupling loss.

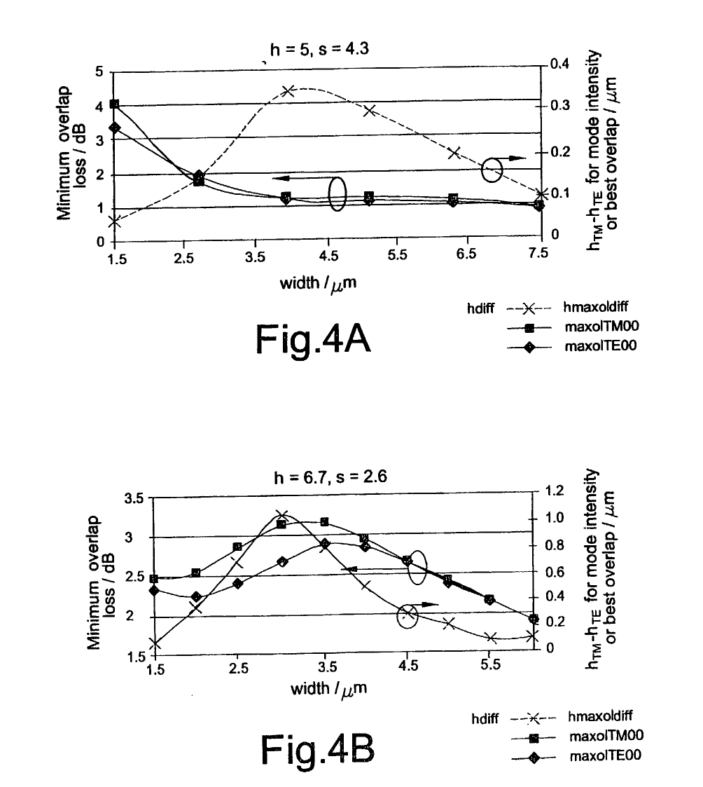

In FIGS. 4A and 4B the actual minimum overlap loss is plotted against width for two different etch depths (5 μm and 6.7 μm), together with the TM−TE difference in mode height, or difference in position of maximum overlap. It is the difference in position of maximum overlap that is more important since this determines the range of movement of the fibre. As large a movement as possible is required to provide accurate control of the PDL. The largest height difference is generated for widths around 3-4 μm. The maximum possible difference in height/position of maximum overlap increases with etch depth from about 0.2 μm/0.3 μm for h=5 μm to about 0.6 μm/1.0 μm for h=6.7 μm.

Referring to FIG. 4A, the minimum overlap loss for h=5 μm was about 1 dB, and was minimised at widths for which the height difference was greatest. This occurred for a width of about 3.9 μm. for h=6.7 μm, as shown in FIG. 4B, the loss was in general much larger (2.3 dB) and peaked at about the same width as the TE−TM height difference. This was at a width of about 3.5 μm. Although the loss was larger, this width was used since it would give the largest mode height difference and hence largest possible variation in PDL by moving the fibre.

To gauge the range of PDL it would be possible to generate by moving the fibre, overlap losses were calculated for both polarisations when the fibre was positioned for maximum overlap of one polarisation. These are shown for three different waveguide examples in Table 1.

| | | TE | TM | PDL |
|---|---|---|---|---|
| Polarisation for | Position of | overlap | overlap | (TE-TM) |
| which aligned | Max. Overlap | loss/dB | loss/dB | /dB |
| TE (h = 6.7, w = 3.5) | −0.5 | 2.872 | 3.224 | −0.352 |
| TM (h = 6.7, w = 3.5) | +0.3 | 2.956 | 3.146 | −0.190 |
| TE (h = 5.0, w = 3.9) | −3.1 | 1.189 | 1.261 | −0.072 |
| TM (h = 5.0, w = 3.9) | −2.75 | 1.201 | 1.247 | −0.046 |
| TE (h = 5.0, w = 12.5) | 0.1 | 0.353 | 0.391 | −0.038 |
| TM (h = 5.0, w = 12.5) | 0.1 | 0.353 | 0.391 | −0.038 |

Table 1: Range in PDL values for two geometries: h=5, s=4.3, w=3.9 and h=6.7, s=2.6 and w=3.5

(all dimensions are in microns)

From Table 1 it is seen that, for the shallower etch (5 μm), the change in PDL by moving the fibre is negligible. The PDL is larger for the deeper etch (6.7 μm), and so is the change in PDL. The PDL can be varied from −0.352 dB to −0.190 dB, by moving the fibre up 0.8 μm. This change of 0.162 dB could be used to provide fine control of the PDL. For example, say the TE ‘system’ loss was 3.352 dB and the TM ‘system’ loss was 3.000 dB, the PDL would then be +0.352 dB. If, however, this is followed by the above waveguide design, the fibre can be positioned at −0.5 μm so that the TE coupling loss is minimised to 2.872 dB, while the TM coupling loss is increased to 3.224 dB (a TE−TM difference of −0.352 dB). Hence the overall PDL would be zero.

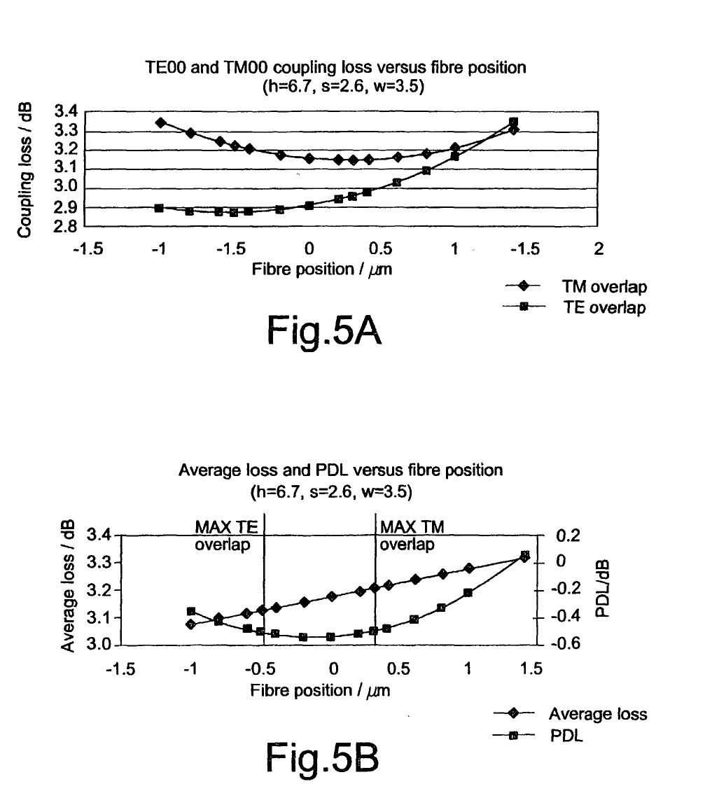

For the dimensions h=6.7, w=3.5, the coupling loss was calculated versus fibre position for both polarisations as shown in FIG. 5A, the position of the fibre being measured from the top surface of the slab. FIG. 5B shows the loss averaged over the two orthogonal polarisations and the PDL, defined as the TE00 loss minus the TM00 loss. The TE loss is less in general because its modal shape correlates slightly better with a fibre mode.

For an average insertion loss of 3-4 dB it is possible to compensate PDL from −0.8 dB to +0.4 dB by moving the fibre from −3.0 μm to +3.0 μm.

Preferably these dimensions should be applied to the cross-section of the output waveguide rather than the input. This is because the design is multimode and movement of the fibre on input would excite higher order modes, resulting in increased loss upon tapering down. However, if used on the output, the power should remain in the fundamental, as tapered up, if done adiabatically. Then the position of the fibre will only determine the relative coupling loss between TE and TM polarisations as required. The above waveguide dimensions (h=6.7 μm, s=2.6 μm and w=3.5 μm) support fundamental modes with significant height differences between TE and TM polarisations. This fact may be used to give a degree of control of the absolute PDL from −0.352 dB to −0.190 dB by moving the fibre 0.8 μm. By moving the fibre outside this range, the coupling PDL may be varied over a broader range, although the absolute coupling losses increase further. This technique may be used for PDL compensation or in any situation for which a vertical separation of the polarisation states is required.

1. A polarisation dependent loss generator for receiving from an optical transmission system an optical signal having first and second polarisation components, the generator comprising a waveguide structure (3, 11) having an input for receiving an optical signal and an output, and having a geometry such that the first and second polarisation components have different extents within the height of the waveguide structure (3, 11), and an optical element (6, 10) optically coupled to the input or the output of the waveguide structure (3, 11) and positioned relative to the waveguide structure (3, 11) so as to generate different optical coupling losses for the first and second polarisation components as a result of the different overlaps of the optical element (6, 10) with the different lateral extents of the first and second polarisation components, in order to at least partially compensate for the polarisation dependent losses of the transmission system.

2. A generator according to claim 1, wherein the optical element (6, 10) is arranged to apply a first loss to the first polarisation component and a second loss to the second polarisation component such that the sum of the first loss and the loss for the first polarisation component from the transmission system is substantially the same as the sum of the second loss and the loss for the second polarisation component from the transmission system.

3. A generator according to claim 1, wherein the optical element (6, 10) includes an output optical conductor having an end coupled to an output end of the waveguide structure (3, 11), the output optical conductor end being offset relative to the optical axis of the output end of the waveguide structure (3, 11) so as to introduce coupling losses for at least one of the first and second polarisation components.

4. A generator according to claim 3, wherein adjustment means (14) is provided for adjusting the degree of coupling between the optical element (6, 10) and the output of the waveguide structure (3, 11).

5. A generator according to claim 1, wherein the optical element (6, 10) includes an input optical conductor having an end coupled to an input end of the waveguide structure (3, 11), the input optical conductor end being offset relative to the optical axis of the input end of the waveguide structure (3, 11) so as to introduce coupling losses for at least one of the first and second polarisation components.

6. A generator according to claim 5, wherein adjustment means is provided for adjusting the degree of coupling between the optical element (6, 10) and the input of the waveguide structure (3, 11).

7. A generator according to claim 4, wherein control means (15, 16) is provided for monitoring the output of the generator and for controlling the adjustment means (14) to vary the degree of coupling in dependence on the required output.

8. A generator according to claim 4, wherein the adjustment means (14) incorporates piezoelectric means for adjusting the position of the optical element end relative to the waveguide structure (3, 11).

9. A generator according to claim 4, wherein the adjustment means incorporates microelectromechanical means for adjusting the position of the optical element end relative to the waveguide structure (3, 11).

10. A generator according to claim 1, wherein the optical element is an optical fibre.

11. A generator according to claim 1, wherein the optical element is a waveguide.

12. A generator according to claim 1, wherein the optical element is a photodiode.

13. A generator according to claim 1, wherein reflecting means is provided for reflecting the optical signal from the output end of the waveguide structure towards the optical element with an alignment relative to the waveguide structure to generate different optical coupling losses for the first and second polarisation components.

14. A generator according to claim 1, wherein an inline polarisation controller (17) is provided for supplying reference signals of different polarisations to the waveguide structure (3, 11) to enable the losses for the different polarisation components to be calibrated.

15. A system incorporating two or more generators according to claim 1 connected in cascade.

16. A method of generating polarisation dependent losses comprising receiving an optical signal having first and second polarisation components from an optical transmission system, introducing said optical signal to a waveguide structure (3, 11) for separating the first and second polarisation components, and applying a first coupling loss to the first polarisation component and a second coupling loss to the second polarisation component.

17. A method according to claim 16, wherein the first coupling loss applied to the first polarisation component and the second coupling loss applied to the second polarisation component are such that the sum of the first loss and the loss for the first polarisation component from the transmission system is substantially the same as the sum of the second loss and the loss for the second polarisation component from the transmission system.
